(19) United States
(12) Patent Application Publication
(10) Pub. No.: US 2026/0329981 A1
(43) Pub. Date: Oct. 22, 2026

(54) METHODS AND SYSTEMS FOR TAMPER-RESISTANT FEDERATED ARTIFICIAL INTELLIGENCE COMPLIANCE AND GOVERNANCE USING SECURE MULTIPARTY COMPUTATION, CRYPTOGRAPHIC WATERMARKING, AND MODEL DRIFT DETECTION IN DISCONNECTED OR ADVERSARIAL ENVIRONMENTS

(71) Applicant: Forward Edge-AI, Inc., San Antonio, TX (US)

(72) Inventors: Eric A. Adolphe, San Antonio, TX (US); Kevin L. Jackson, Manassas, VA (US); Thomas Summe, San Antonio, TX (US)

(21) Appl. No.: 19/649,696

(22) Filed: Apr. 16, 2026

Related U.S. Application Data
(60) Provisional application No. 63/791,033, filed on Apr. 18, 2025.

(51) Int. Cl. G06F 21/16; G06F 21/62; H04L 9/00; H04L 9/32

(52) U.S. Cl. CPC G06F 21/16; G06F 21/6245; H04L 9/3247; H04L 9/50; H04L 2209/46; H04L 2209/608

(57) ABSTRACT

An embodiment of the present invention is directed to a decentralized system and method for lifecycle governance, compliance, and behavioral assurance of artificial intelligence (Al) models, particularly in disconnected, adversarial, or zero-trust environments. The system comprises an integrated architecture that includes a blockchain-based ledger for immutable logging of model provenance and compliance events, a secure multiparty computation (SMPC) engine for privacy-preserving validation of models and updates, a cryptographic watermarking module for embedding blind, tamper-resistant signatures within model parameters and architecture that supports federated learning across disconnected nodes, allowing for local model training and secure aggregation of updates without data centralization. The invention further includes a compliance enforcement engine that autonomously triggers policy actions such as rollback, model quarantine, or kill-switch activation based on predefined rules stored in smart contracts.

### CROSS-REFERNCE TO RELATED APPLICATIONS

This application claims priority to U.S. Application No. 63/791,033, titled “Methods and Systems for Tamper-Resistant Federated Artificial Intelligence Compliance and Governance using Secure Multiparty Computation, Cryptographic Watermarking, and Model Drift Detection in Disconnected or Adversarial Environments,” filed Apr. 18, 2025, which is hereby incorporated by reference in its entirety.

### STATEMENT AS TO FEDERALLY SPONSORED RESEARCH

This invention was made with Government support under the Small Business Innovation Research (SBIR) Funding Award No. 2327618 awarded by the National Science Foundation (NSF). The Government has certain rights to this invention.

### FIELD OF INVENTION

The present disclosure relates to artificial intelligence governance and compliance systems, and more particularly to a decentralized, tamper-resistant system for ensuring the integrity, compliance, and accountability of machine learning models deployed in disconnected, adversarial, or zero-trust environments using secure multiparty computation, blockchain-based provenance tracking, cryptographic watermarking, and model drift detection.

### BACKGROUND

Over the past decade, the United States has witnessed exponential growth in the use of artificial intelligence (Al) across high-risk sectors such as defense, space, finance, and healthcare. This widespread adoption has introduced a foundational challenge: how to ensure the integrity, transparency, and accountability of Al systems that are increasingly autonomous, difficult to inspect, and often deployed in disconnected or adversarial environments. Traditional oversight mechanisms—designed for terrestrial, centralized systems—are proving inadequate in managing the lifecycle risks and compliance requirements of modern Al, particularly as models become black-boxed, proprietary, and dynamically updated outside of human review. The problem is not simply technical but strategic, as ungoverned Al behavior could trigger geopolitical instability, mission failure, or ethical violations.

In 2012, the Intelligence Community's AIM Strategy called attention to the need for scalable, transparent Al systems capable of augmenting human decision-making without eroding trust or accountability. It emphasized the importance of fusing human judgment with machine speed and advocated for lifecycle traceability in Al development. However, the technical infrastructure to operationalize those ideals—particularly in environments like low Earth orbit or battlefield communications—has remained elusive. More recently, the Superintelligence Strategy introduced the doctrine of Mutual Assured Al Malfunction (MAIM), warning of the national security risks posed by opaque or uncontrollable Al systems and emphasizing the need for proactive deterrence and verifiable safeguards. These calls for architectural trust have catalyzed a new generation of solutions focused not just on performance, but on provenance, policy enforcement, and transparency-by-design.

The National Institute of Standards and Technology (NIST) further advanced this conversation with the release of the Al Risk Management Framework (RMF), which outlines a lifecycle-based approach to mapping, measuring, and managing Al risk. However, the framework does not prescribe specific tools—leaving developers, agencies, and compliance officers to bridge a critical operational gap.

Accordingly, there is a need for an improved system and method that can embed governance capabilities directly into AI infrastructure, enabling continuous verification of model integrity, privacy-preserving validation across multiple stakeholders, and autonomous enforcement of compliance policies in environments where traditional centralized oversight is impractical or unavailable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an embodiment of the present invention, a system for decentralized governance and compliance of artificial intelligence (AI) models is provided. The system comprises: a blockchain-based ledger configured to immutably record lifecycle events of an Al model, wherein the lifecycle events comprise training metadata, configuration changes, updates, compliance validations, and operational deviations; a secure multiparty computation (SMPC) engine configured to perform privacy-preserving validation of Al models or model updates across a plurality of federated parties without revealing sensitive internal model information or proprietary validation criteria; a watermarking module configured to embed one or more blind cryptographic watermarks within internal components of the Al model, wherein the one or more blind cryptographic watermarks are verifiable through one or more cryptographic keys or zero-knowledge proofs and resilient to tampering; a compliance enforcement module configured to autonomously trigger predefined policy responses based on conditions stored in smart contracts on the blockchain-based ledger, wherein the predefined policy responses comprise: rollback, model quarantine, or activation of a kill-switch; and wherein the system is operable in disconnected or adversarial environments and further configured to synchronize cached ledger data with a global ledger when connectivity is reestablished.

According to another embodiment of the present invention, a method for decentralized compliance assurance of an artificial intelligence model is provided. The method comprises: training the artificial intelligence model at a local node using local data; embedding a blind cryptographic watermark into the artificial intelligence model during or after training; validating the artificial intelligence model using a secure multiparty computation protocol across a plurality of validating parties without revealing sensitive internal model information of any validating party to other validating parties; logging validation results and model metadata to a blockchain-based ledger configured to immutably record the validation results and the model metadata; and enforcing compliance policies via smart contracts based on predefined rules stored on the blockchain-based ledger.

According to another embodiment of the present invention, a non-transitory computer-readable medium storing executable instructions which, when executed by a processor, cause an artificial intelligence governance system to: monitor inference outputs of an artificial intelligence model in real-time; initiate federated validation using secure multiparty computation when a model update is proposed, the federated validation performed across a plurality of validation parties without revealing sensitive internal model information of any validation party to other validation parties; verify embedded cryptographic watermarks against blockchain ledger entries to confirm model integrity; and execute smart contracts stored on a blockchain-based ledger to enforce compliance outcomes without human intervention.

An embodiment of the present invention operates at the frontier of Al governance, offering a tamper-resistant, cryptographically verifiable system for ensuring the integrity, compliance, and accountability of machine learning models deployed in disconnected, adversarial, or zero-trust environments such as space, defense, and critical infrastructure. By integrating secure multiparty computation, blockchain-based provenance tracking, and blind watermarking, an embodiment of the present invention enables real-time anomaly detection, federated model validation, and decentralized kill-switch enforcement without requiring access to sensitive model internals. This architecture transforms traditional compliance from a post-hoc audit into a continuous, embedded protocol layer—allowing Al systems to self-verify, trace their lineage, and align with mission-critical policy constraints in real time.

Unlike conventional model governance systems that rely on post-hoc documentation or cloud-native monitoring, an embodiment of the present invention embeds governance into the infrastructure itself—cryptographically recording every model update, enabling zero-knowledge proofs of compliance, and automating anomaly detection through topological analysis. This approach ensures that trust in Al is not assumed, but continuously verified—even in contested or bandwidth-constrained domains.

An embodiment of the present invention is directed to a strategic infrastructure designed to align with emerging U.S. policy on trustworthy and mission-assured Al. It serves as a compliance enforcement engine and as a deterrence mechanism, ensuring that any Al model, whether developed in a secure laboratory or acquired from an external vendor, can be independently verified for safety, traceability, and alignment with U.S. ethical and security standards. By embedding compliance at the protocol layer and enabling privacy-preserving, decentralized oversight, an embodiment of the present invention empowers government agencies, coalition partners, and regulated industries to deploy Al with confidence—transforming governance from an afterthought into a core architectural feature.

The foregoing general description of the illustrative embodiments and the following detailed description thereof are merely exemplary aspects of the teachings of this disclosure and are not restrictive.

### BRIEF DESCRIPTION OF FIGURES

In order to facilitate a fuller understanding of the invention, reference is made to the attached drawings. The drawings should not be construed as limiting the invention, but are intended only to illustrate different aspects and embodiments of the invention.

FIG. 1 illustrates a block diagram illustrating a structural architecture of an AI Compliance System, according to an embodiment of the present invention.

FIG. 2 illustrates a schematic representation of an operational workflow, according to an embodiment of the present invention.

FIG. 3 illustrates a flowchart illustrating a model watermarking process, according to an embodiment of the present invention.

FIG. 4 illustrates a flowchart illustrating a model drift detection process, according to an embodiment of the present invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

An embodiment of the present invention is directed to a decentralized, tamper-resistant system for governing artificial intelligence (Al) models in high-risk, zero-trust, or disconnected environments, such as space platforms, defense systems, critical infrastructure, and regulated commercial sectors. An embodiment of the present invention provides a comprehensive compliance and assurance architecture that embeds security, auditability, and lifecycle traceability directly into the Al model pipeline. It integrates multiple cryptographic and privacy-preserving technologies, including blockchain-based provenance tracking, secure multiparty computation (SMPC), multi-layer blind watermarking, and topological model drift detection. These features collectively address the urgent need for explainable, resilient, and policy-aligned Al governance in mission-critical domains.

An embodiment of the present invention enables a novel method of Al validation and compliance that functions independently of human oversight or access to model internals. Using SMPC, multiple stakeholders, including government agencies, allied entities, and regulated organizations, can jointly verify a model's behavior, provenance, and risk profile without revealing sensitive data or proprietary model architectures. This privacy-preserving protocol ensures that even black-box Al models acquired from third-party vendors can be independently validated against regulatory benchmarks such as those outlined in the National Institute of Standards and Technology (NIST) Al Risk Management Framework (RMF).

An embodiment of the present invention further incorporates a blockchain-backed ledger system that captures an immutable, time-stamped record of every event in a model's lifecycle, including training parameters, version histories, configuration changes, and compliance status. Smart contracts embedded in the ledger enable real-time enforcement of policy constraints, kill-switch activation, and rollback protocols in the event of model failure or deviation. This ensures that governance actions can be executed autonomously, without reliance on centralized control or external monitoring infrastructure—ideal for environments with latency constraints, contested communications, or limited human access.

An embodiment of the present invention is directed to a multi-layer blind watermarking technique where watermarks are embedded invisibly across the model's weights, gradients, and/or decision layers, providing cryptographic proof of authorship and integrity. These watermarks may be referenced and verified using SMPC and blockchain hashes, ensuring forensic traceability while preserving model performance. The watermarking process may be designed to be non-invasive and resilient against adversarial modification, enabling downstream validation and ownership claims without exposing internal model details.

To address the risk of model drift, inference anomalies, and adversarial tampering especially in unlabeled or synthetic data environments, an embodiment of the present invention incorporates a Model-Agnostic Detection of Deviation (MAD-D) framework. The MAD-D framework utilizes topological and geometric analysis to detect structural deviations in model behavior over time. These alerts can be visualized and acted upon through a user interface, such as a wiki-style graphical user interface (GUI) that maps model lineage, displays performance drift, and integrates with real-time policy enforcement mechanisms. This allows mission stakeholders to maintain continuous situational awareness of Al models, even in highly dynamic or adversarial environments.

An embodiment of the present invention also supports secure federated learning, allowing Al models to be trained across distributed networks without centralizing sensitive data. SMPC and differential privacy techniques are used to ensure that training contributions remain confidential while enabling joint optimization across coalition partners or data-siloed organizations. Each federated contribution is recorded and auditable through the same blockchain and watermarking infrastructure, ensuring end-to-end transparency and compliance across the training lifecycle.

Collectively, an embodiment of the present invention introduces a holistic, infrastructure-level approach to Al assurance that moves beyond traditional post-hoc audit tools and manual review processes. By combining cryptographic validation, policy automation, privacy-preserving computation, and real-time drift detection into a single interoperable architecture, the system ensures that Al models remain safe, aligned, and trustworthy from training to deployment. This system is particularly suited for deployment in operational theaters where Al must function autonomously and where oversight cannot depend on connectivity, manual inspection, or static policy enforcement mechanisms. Other deployments and implementations may be supported.

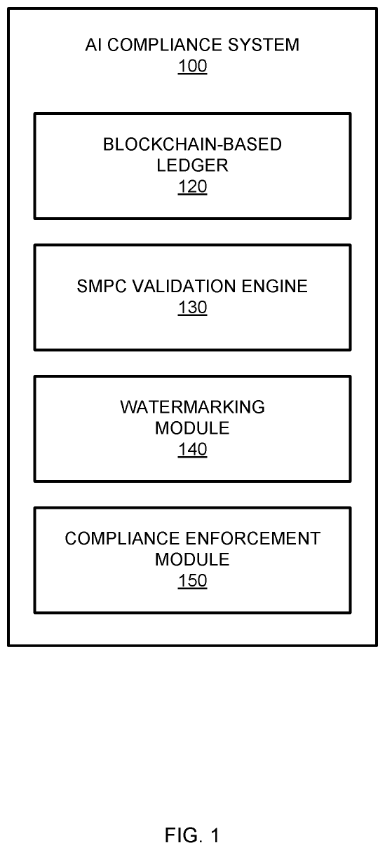

FIG. 1 illustrates a block diagram illustrating a structural architecture of an AI Compliance System, according to an embodiment of the present invention. FIG. 1 illustrates the structural architecture of Al Compliance System 100, which provides a decentralized, tamper-resistant platform for the governance and validation of artificial intelligence models operating in disconnected, adversarial, or high-assurance environments.

As shown in FIG. 1, the system includes a Blockchain-Based Ledger 120, a Secure Multiparty Computation (SMPC) Validation Engine 130, and a Watermarking Module 140, each of which performs a distinct but interrelated role in establishing a trusted Al lifecycle. An optional module, such as Compliance Enforcement Module 150, may also be provided.

These interdependent components are tightly integrated into a unified compliance infrastructure that continuously oversees and enforces the integrity of artificial intelligence (Al) and machine learning (ML) models. The system is designed to provide lifecycle governance from the earliest stages of model development through training, deployment, inference, retraining, and eventual decommissioning. Each component plays a distinct role while reinforcing the others, creating a resilient, tamper-evident framework capable of operating in disconnected or adversarial environments.

Blockchain-Based Ledger 120 serves as the backbone for secure, immutable record-keeping throughout the entire model lifecycle. It is configured to log and store time-stamped entries related to model training events, parameter updates, configuration changes, validation approvals, compliance checkpoints, and policy enforcement actions. These entries are cryptographically hashed and chained in a manner that ensures tamper resistance and auditability across stakeholders, even in environments where network trust is minimal or non-existent.

Blockchain-Based Ledger 120 functions as the system's immutable memory and policy execution substrate. Events relevant to the model's lifecycle may be encoded, hashed, and committed to this ledger. Such events may include initial training, configuration modifications, validation approvals, inference anomalies, policy violations, etc. Unlike traditional databases, which can be altered or deleted, blockchain ensures that all entries are cryptographically chained and append-only, enabling retrospective audits and forensic analysis well after deployment.

Blockchain-Based Ledger 120 is also programmable through smart contracts, which execute predefined compliance actions such as halting model execution, triggering revalidation workflows, or broadcasting policy alerts when specific conditions are met. Smart contracts may be deployed within the ledger to automate rule enforcement and trigger security controls such as model rollback, kill-switch activation, or policy flagging when violations or deviations are detected.

Blockchain-Based Ledger 120 further supports offline caching to accommodate disconnected or low-bandwidth environments. Events recorded locally in the field may be synchronized with the central ledger once a secure connection is re-established. This enables the Al model to maintain compliance continuity, even when temporarily severed from central governance infrastructure—a critical feature for deployments in space, battlefield conditions, or hardened critical infrastructure networks.

SMPC Validation Engine 130 enables privacy-preserving, collaborative assessment of Al model behavior and compliance status across multiple independent stakeholders. It is configured to allow two or more validation parties to jointly compute the outcome of compliance tests, policy evaluations, and/or behavioral analysis without exposing their private data or internal model parameters to one another. This functionality is especially critical for validating proprietary or third-party “black-box” models where source code, training data, or weights are not publicly accessible. SMPC Validation Engine 130 ensures that decisions regarding trust, deployment, and/or revocation of an Al model can be made based on verifiable evidence, without compromising confidentiality or intellectual property rights.

SMPC Validation Engine 130 represents a federated trust mechanism that allows multiple independent validators, such as internal auditors, coalition partners, regulators, or mission commanders, to jointly assess a model's compliance status without revealing their respective proprietary data or internal evaluation logic. Each participating node inputs encrypted or secret-shared data into the computation. SMPC Validation Engine 130 securely computes a collective verdict without exposing any participant's inputs. This enables decentralized trust decisions and prevents any single point of compromise or unilateral override. It also empowers organizations to perform third-party validation of externally developed models (e.g., from vendors or subcontractors) without requiring source code or direct access to sensitive internal components.

Watermarking Module 140 is responsible for embedding one or more invisible, cryptographically secure signatures—referred to as blind watermarks—into the Al or machine learning model during the training or configuration phase. These watermarks are designed to be performance-neutral and resilient to tampering, enabling stakeholders to verify model authorship, integrity, and provenance even after the model has been deployed or transferred across environments. Watermarking Module 140 interfaces with Blockchain-Based Ledger 120 to store and reference corresponding watermark metadata, thereby supporting forensic analysis and lifecycle traceability in the event of a compliance investigation or adversarial incident.

Watermarking Module 140 provides cryptographic provenance and model identity assurance by embedding robust, blind digital signatures directly into the Al model. These signatures may be encoded within weight matrices, bias vectors, architectural pathways, and/or other mathematical features that are functionally inert but cryptographically meaningful. The resulting watermark cannot be detected or removed through standard analysis or reverse engineering, yet it can be independently verified using the appropriate cryptographic key or zero-knowledge proof protocol. This guarantees that any distributed model may prove its origin and authenticity without relying on external documentation or unverifiable claims—a key requirement for coalition environments or regulatory enforcement.

Furthermore, these watermarks may be tightly coupled with Blockchain-Based Ledger 120, where a hash of each embedded signature is recorded alongside its issuance context (e.g., model version, issuer identifier, time of embedding, etc.). This linkage supports real-time authentication, lifecycle tracking, and forensic traceback if a compromised model is detected in the field. It also prevents model forgery, unauthorized transfer, or modification, since any alteration to the underlying watermark would result in a cryptographic mismatch with the recorded ledger entry.

According to an embodiment of the present invention, Compliance Enforcement Module 150 may be optional. Compliance Enforcement Module 150 may autonomously trigger predefined policy responses based on conditions stored in smart contracts on Blockchain-Based Ledger 120. Policy responses may include rollback, model quarantine, or activation of a kill-switch. Compliance Enforcement Module 150 may autonomously perform model rollback to a previously verified state based on drift detection signals or failed validations.

Together, the modules shown in FIG. 1 form an integrated Al assurance system capable of governing autonomous decision-making systems in real time, while maintaining transparency, traceability, and trustworthiness across decentralized or contested domains. The combination of these modules establish a layered and interoperable foundation for trusted Al governance. This integration provides an ability to shift Al assurance from an external, retrospective process into an embedded, autonomous function of the Al system itself. The platform empowers models to continuously validate their own integrity, defend against unauthorized changes, and enforce compliance even in the most hostile or disconnected conditions. Accordingly, an embodiment of the present invention ensures the security, resilience, and policy alignment of next-generation Al deployments.

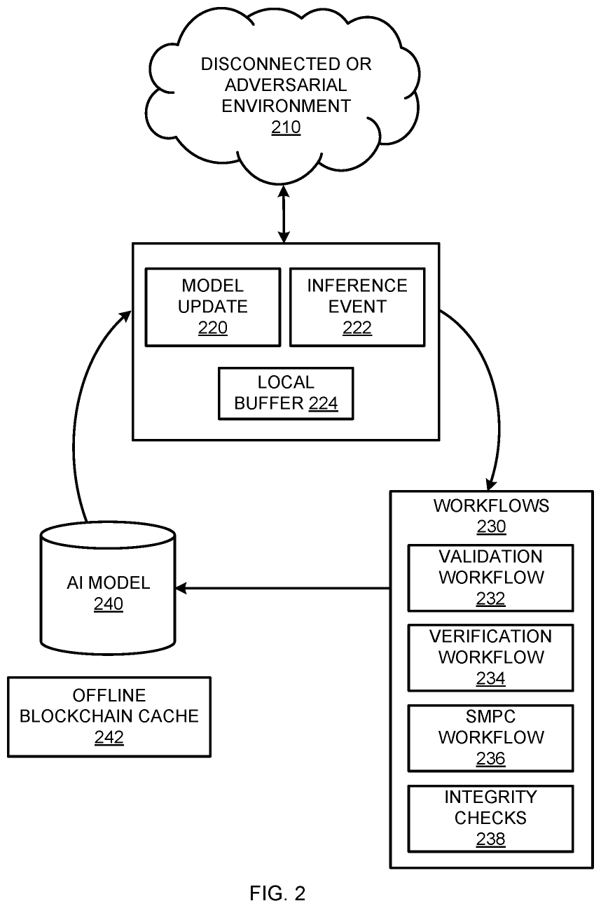

FIG. 2 illustrates a schematic representation of an operational workflow, according to an embodiment of the present invention. FIG. 2 illustrates an operational workflow for deploying and managing artificial intelligence (Al) models in disconnected, zero-trust, or adversarial environments, as shown by 210. FIG. 2 highlights how an Al system maintains governance, validation, and integrity enforcement despite the absence of reliable network connectivity, centralized oversight, or secure infrastructure—conditions commonly encountered in space operations, battlefield systems, and critical infrastructure networks.

The operational workflow may be designed to support secure, compliant, and autonomous functioning of Al models in environments where traditional centralized oversight is impractical or impossible. These environments may include orbital platforms, tactical battlefield networks, disconnected sensor grids, and coalition Al deployments where latency, security constraints, or regulatory diversity may prevent real-time supervisory control. The workflow manages not only real-time inference monitoring but also decentralized validation, tamper response, and secure update integration thereby creating an adaptive trust infrastructure embedded directly within the operational Al lifecycle.

As shown by FIG. 2, the process may begin with a continuous monitoring of Inference Events 222 produced by the deployed Al model, as shown by 240. Inference Events 222 may include input data signatures, output classifications or recommendations, confidence levels, and performance metadata. Even in severely bandwidth-constrained environments, this telemetry may be buffered locally, as shown by Local Buffer 224, and periodically summarized for transmission to oversight modules or peer nodes. The local inference history forms a contextual timeline that supports later auditing, forensic inspection, or model rollback in the event of behavioral deviation, misclassification, or adversarial exploitation.

According to an embodiment of the present invention, the workflow may operate in an Al model execution environment, which may be instantiated on edge computing hardware, nano-and microsatellites (e.g., CubeSats), field-deployed autonomous systems, or other mission-critical platforms. The environment may be designed to support local inference operations, including data ingestion, prediction generation, decision-making, and response actuation. During each inference cycle, metadata related to model behavior, input-output characteristics, and decision rationale may be logged in a secure, local buffer to ensure subsequent auditability even in the absence of continuous uplink or supervisory review.

An embodiment of the present invention periodically receives or initiates Model Updates 220, which may include re-training instructions, configuration changes, parameter tuning, or external policy injections. Because these updates may originate from disconnected sources (e.g., mission control, allied coalition partners, authenticated offline media, etc.), each update may be first routed through a set of workflows, as shown by 230, before integration into the active model.

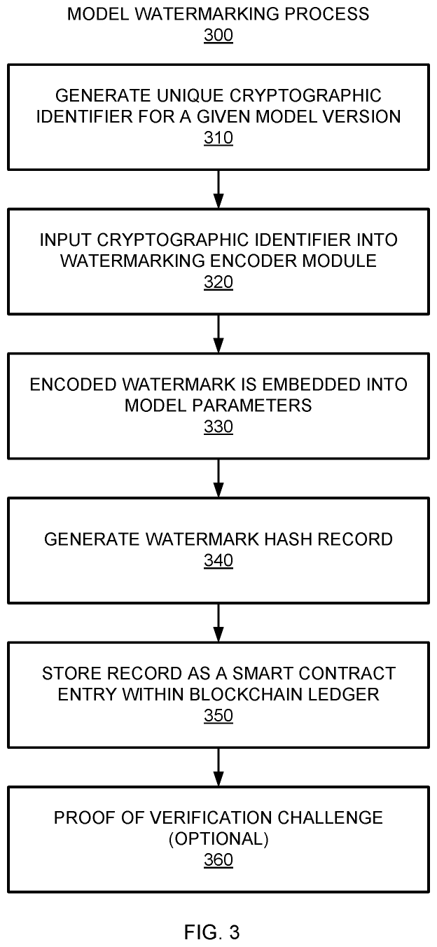

The set of workflows may include various integrity checks including multi-step integrity checks, such as Validation Workflow 232, Verification Workflow 234, and SMPC Workflow 236 and other integrity checks as shown by Integrity Checks 238. Verification Workflow 234 may include verification of digital signatures. Validation Workflow 232 may include validation of embedded blind watermarks (as described in FIG. 3 below). Secure Multiparty Computation (SMPC) workflow 238 may represent consensus-based authentication. For example, SMPC workflow 238 allows multiple distributed validators, such as agency nodes, coalition partners, or independent compliance auditors, to assess the legitimacy and trustworthiness of the proposed model update or behavioral profile without revealing any sensitive internals. Each validator contributes encrypted, privacy-preserving assessments that may be aggregated to reach a policy-based consensus.

According to an embodiment of the present invention, when a model update is initiated—whether through planned retraining, policy adjustments, new data ingestion, or external firmware integration—it is not automatically applied to the active model. Instead, the update may be routed through Secure Multiparty Computation (SMPC) validation engine. Here, multiple validation stakeholders (e.g., internal policy officers, third-party auditors, coalition representatives) contribute encrypted inputs that are securely aggregated and computed without any party revealing their internal evaluation criteria or proprietary data.

Only upon successful validation by the quorum of trusted nodes is the update incorporated into an AI Model, as shown by 240, with associated metadata logged to an Offline Blockchain Cache 242. For example, only if the consensus of validators confirms that the update meets predefined compliance thresholds will it be integrated into the active Al Model, as shown by 240. The SMPC validation outcome, along with metadata about the update (e.g., origin, timestamp, update type, etc.), may then be logged to an Offline Blockchain Cache 242 which may be co-located with the Al system.

Offline Blockchain Cache 242 serves as a tamper-evident ledger of all lifecycle events, which may later be synchronized with a global ledger (e.g., upon reconnection with secure cloud infrastructure). Events stored in this cache may include model updates, compliance validations, inference anomalies, rollback activations, watermark verification hashes, etc. This ensures that, even in adversarial or disconnected environments, the complete operational history of the Al model remains traceable and auditable. Accordingly, Offline Blockchain Cache 242 maintains continuity of compliance, even when global synchronization with a central authority is temporarily unavailable. Offline Blockchain Cache 242 stores update provenance, validation signatures, and associated inference patterns, ensuring traceability across update cycles and supporting local accountability during disconnection or contested deployment.

In cases where real-time anomalies are detected, such as structural drift, adversarial behavior, and/or inference inconsistency, the model may autonomously trigger a kill-switch or rollback protocol governed by smart contracts or symbolic execution constraints. This mechanism prevents continued operation of a compromised or misaligned Al agent and ensures fail-safe behavior until revalidation is possible.

Collectively, FIG. 2 illustrates how an embodiment of the present invention maintains compliance, trust, and operational integrity across the full Al lifecycle, even under conditions of constrained communication, adversarial threat vectors, or coalition deployment scenarios. The workflow is designed to support scalable federation, autonomous decision checkpoints, and cryptographic trust guarantees in high-consequence domains.

When the Al system regains access to a secure network or command infrastructure, Offline Blockchain Cache 242 may be synchronized with a global ledger, enabling external stakeholders-such as mission control, regulators, or federated partners—to reconcile local behaviors with broader system-wide expectations. This design guarantees that all lifecycle events, including those occurring in isolation, are eventually incorporated into a unified, authoritative compliance record. The synchronization process also helps surface hidden anomalies or latent drift that may not have been evident in the isolated environment.

In the event of anomalous behavior, suspected adversarial tampering, or structural model drift, the system may autonomously trigger a local or distributed rollback protocol. This rollback mechanism is governed by smart contracts or symbolic execution constraints embedded within the model's compliance layer. Depending on the severity and classification of the anomaly, the rollback may revert to the last verified model state, suspend high-risk inference functions, or fully deactivate the system. Additionally, quorum-based kill-switch enforcement may be activated through SMPC, requiring a predetermined number of independent validators to authorize the model's shutdown or operational quarantine—providing an extra layer of resilience and ethical control in disconnected domains. This operational workflow ensures that Al oversight is transformed from a static audit process into a continuous, embedded compliance system. It enables autonomous models to remain aligned with mission objectives, legal frameworks, and safety thresholds, even when deployed at the edge of connectivity or in environments where human intervention is infeasible. By integrating inference monitoring, federated validation, blockchain-based traceability, and autonomous enforcement into a seamless lifecycle process, an embodiment of the present invention provides a blueprint for mission-assured, policy-compliant Al in the most challenging operational settings.

FIG. 3 illustrates a flowchart illustrating a model watermarking process, according to an embodiment of the present invention.

The flowchart depicts detailed operations of the model watermarking process (300), which relates to compliance and provenance infrastructure. The process enables the embedding of cryptographically resilient, performance-neutral identifiers (or blind watermarks) directly into an internal architecture of artificial intelligence or machine learning (Al/ML) models. These watermarks serve to establish verifiable authorship, detect unauthorized tampering, and enable forensic traceability across the model's operational lifecycle. An embodiment of the present invention is directed to ensuring that every Al model is uniquely identifiable, traceable, and protected against unauthorized tampering or forgery. While the process of FIG. 3 illustrates certain steps performed in a particular order, it should be understood that the embodiments of the present invention may be practiced by adding one or more steps to the processes, omitting steps within the processes and/or altering the order in which one or more steps are performed. Additional details for each step may be provided below.

At step 310, a unique cryptographic identifier (CID) may be generated for a given model version. The CID may be derived from a secure hash of the model's architecture, training data digest, hyperparameter configuration, and/or timestamp metadata. Optionally, the identifier may also incorporate a public key associated with the model's originator to facilitate later signature verification. For example, the CID may represent a hash-based signature derived from critical model attributes such as its training dataset digest, hyperparameter configuration, architecture specification, and temporal metadata. The CID may act as a digital fingerprint for a specific model version and establishes the foundation for linking the model to its originator and associated compliance context.

At step 320, the CID may serve as an input into a watermark encoder module. The watermark encoder module may transform the cryptographic identifier into a form suitable for embedding within the model. This may involve encoding the watermark into numerical patterns, vector perturbations, and/or structural artifacts that are statistically indistinguishable from legitimate model parameters but remain recoverable through a secret verification key. The encoding process may be adapted to target specific layers or components of the model, such as weight matrices, gradient flows, activation paths, etc., based on the model type (e.g., neural network, decision tree, transformer, etc.).

For example, the CID may be transformed into a non-obvious watermark pattern, using encoding schemes designed to maintain the operational performance and accuracy of the Al model. The encoded watermark may be injected into the model's internal structure, such as weight matrices, activation paths, and/or decision thresholds-using precision perturbations that may be indistinguishable from standard parameter noise during normal operation.

At step 330, the encoded watermark may be embedded into the model parameters during an initial training or a secure post-training augmentation phase. This embedding may be designed to be blind, meaning that the watermark is not easily detectable or removable without the corresponding key or hash reference. These watermarks cannot be detected or reverse-engineered through model introspection or side-channel analysis. The embedded signature does not alter model performance or inference behavior but acts as a hidden integrity marker that persists across deployments, including edge environments, black-box access scenarios, etc. Furthermore, multiple layers of watermarking may be used to embed redundant or multi-party signatures, supporting coalition attribution and layered compliance protocols.

At step 340, a watermark hash record may be generated after successful embedding. The watermark may link to the cryptographic watermark to the model's version, origin metadata, and/or compliance state. For example, an embodiment of the present invention may compute a secure hash of the watermark and its corresponding metadata, including details such as the issuing organization, time of embedding, compliance flags, expiration rules, licensing scope, etc.

At step 350, this record may be stored as a smart contract entry within the immutable blockchain ledger. This ledger entry allows for later verification of the model's authenticity, update history, and/or chain-of-custody through a secure and tamper-resistant audit trail.

For example, the hash, along with a pointer to the full metadata object, may be recorded immutably on the blockchain ledger. The blockchain entry provides tamper-evident proof of the model's origin and compliance status, ensuring that any future recipient or regulator may verify its authenticity without relying on the model developer or distributor to supply external documentation. The embedded provenance system also enables post-deployment model auditing and validation, particularly useful in disconnected or adversarial environments where centralized oversight is unavailable. When a stakeholder, such as a coalition partner or regulatory authority, receives a deployed model or detects suspicious behavior, they may initiate a zero-knowledge proof or SMPC-based verification to confirm the watermark's presence and match it to a blockchain ledger entry, without requiring access to the model's internals. This approach balances transparency and protection, providing trust without sacrificing proprietary value or compromising security.

Ultimately, the watermarking and provenance embedding process ensures that every model instance carries a verifiable, non-removable identity that reflects its origin, evolution, and compliance posture. This capability transforms the Al model from a “black box” into a traceable, accountable asset—supporting lifecycle assurance, regulatory interoperability, and trusted deployment across public, private, and hybrid networks. It provides a foundational mechanism for decentralized governance, enabling mission-critical Al to function with the same or similar level of auditability and trust as cryptographically signed software in high-assurance computing environments.

At step 360, an optional proof-of-verification challenge may be performed. With the proof-of-verification challenge, an authorized validator (e.g., a compliance officer, mission operator, regulatory node, etc.) may query the model in a non-invasive manner to retrieve and confirm the presence of the embedded watermark using zero-knowledge proofs or secure multiparty computation. This ensures that even in disconnected or adversarial environments, model integrity may be confirmed without exposing internal architecture or sensitive parameters. The model watermarking process shown in FIG. 3 provides a scalable and cryptographically sound mechanism for embedding verifiable lineage into Al/ML systems. It supports lifecycle traceability, ownership enforcement, and forensic accountability, which are core requirements for deploying Al systems in environments where provenance, reproducibility, and compliance are paramount.

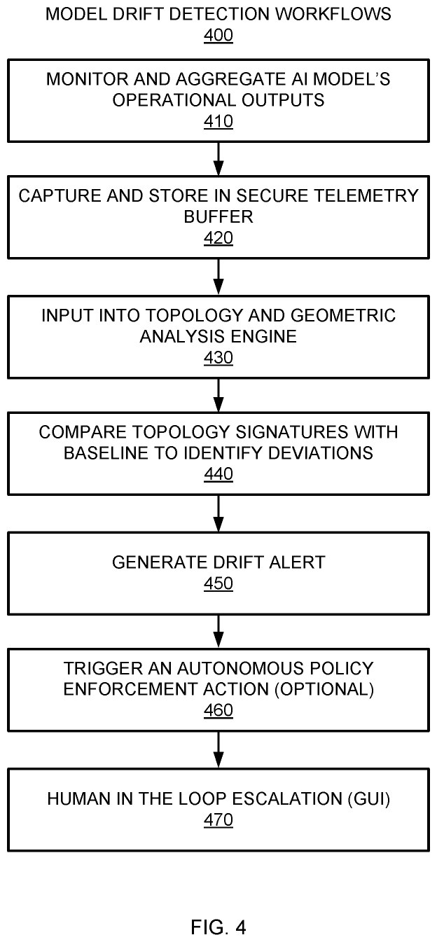

FIG. 4 illustrates a flowchart illustrating a model drift detection process, according to an embodiment of the present invention. The flowchart illustrates the model drift detection workflow 400 designed to detect, flag, and/or respond to subtle or structural deviations in Al model behavior over time. This drift detection process, which may be implemented through the Model-Agnostic Detection of Deviation (MAD-D) framework, enables the identification of anomalous inference patterns, adversarial perturbations, and/or performance shifts that may indicate model corruption, misalignment, and/or misuse. This framework may operate independently of labeled data or demographic-specific benchmarks, making it well-suited for disconnected, synthetic, or data-scarce environments such as orbital or battlefield deployments. While the process of FIG. 4 illustrates certain steps performed in a particular order, it should be understood that the embodiments of the present invention may be practiced by adding one or more steps to the processes, omitting steps within the processes and/or altering the order in which one or more steps are performed. Additional details for each step may be provided below.

According to an embodiment of the present invention, this framework is designed to continuously monitor and assess the behavioral integrity of Al models during deployment and plays a critical role in identifying unintended or malicious changes in model behavior, such as model drift. Unlike conventional approaches that depend on access to ground truth labels or demographic segmentation, the MAD-D framework employs a topological and geometric analysis of the model's decision boundaries and inference space, allowing it to operate even in environments with limited data visibility, such as orbital satellites, battlefield nodes, or synthetic-data training scenarios.

At step 410, the Al model's operational outputs may be monitored and aggregated. Operation outputs may include predictions, confidence scores, and/or internal activations and may be continuously monitored and aggregated into a structured time-series dataset. This data may be collected at regular intervals or triggered by inference events, depending on mission constraints.

For example, step 410 may capture the model's inference signature, namely a high-dimensional representation of how the model transforms input data into output predictions, which may be extracted at regular intervals or upon specific operational triggers.

At step 420, the captured information may be stored in a secure telemetry buffer for local analysis. The captured information may include metadata such as model version, input context, and system state.

At step 430, the buffered data may represent inference patterns that may serve as an input into a topological and geometric analysis engine, which transforms the outputs into a multidimensional feature space. Using techniques such as persistent homology, manifold learning, and/or similarity clustering, the system constructs a behavioral topology representing the structure and evolution of the model's decision space. This allows for comparison between current model behavior and known baselines established during initial training or prior validation checkpoints.

Topology structures may serve as behavior maps that describe not only the output of the model, but the way in which the model reasons about its environment. Importantly, this approach is architecture-agnostic and does not require modification of the underlying model, making it compatible with proprietary and black-box systems. Other mapping techniques may be applied.

At step 440, current topological signatures may be compared with historical baselines to identify deviations. Deviations may take the form of drift (gradual divergence over time), shift (sudden change in data distribution), or anomaly (unexpected output in response to known stimuli). The system evaluates these differences using predefined thresholds, geometric distance metrics, and/or learned sensitivity profiles configured during onboarding. This comparison is model-agnostic as it does not require knowledge of the underlying architecture, data, or weights and may be applied to any model inference trace exhibiting sufficient dimensional characteristics.

For example, a behavioral map may be compared against a baseline signature generated during the model's initial training or following the last authorized update. These baselines may be stored as encrypted templates within the blockchain ledger and include topological features that define “normal” operational zones across various input distributions. By applying geometric similarity metrics, manifold distance calculations, or topological invariants, the system may determine whether the current model behavior is within expected bounds or has drifted into an anomalous regime.

In step 450, when a deviation exceeding the defined risk tolerance is detected, the system generates a drift alert. This alert may be internally logged for audit purposes or externally broadcasted to designated compliance authorities or supervisory systems. Each alert may include supporting telemetry, such as the timestamp of detection, affected model version, affected data segment, and/or a quantified drift index.

At step 460, an alert may trigger an autonomous policy enforcement action such as quarantining the model, activating a kill-switch, or invoking a federated re-validation protocol using SMPC and/or blockchain smart contracts. This may be considered an optional step.

For example, when a predefined deviation threshold has been breached, the system generates a real-time alert and initiates a sequence of automated actions. These actions include the creation of an anomaly incident log, which is appended to the model's compliance record in the blockchain ledger, and the optional initiation of a rollback or revalidation protocol. The incident log includes relevant context, such as the timestamp of detection, deviation severity, affected features or outputs, and the last known compliant state of the model. This immutable log supports post-incident analysis, regulatory audits, and operational review.

At step 470, human-in-the-loop escalation may be provided, where compliance officers, mission operators, or coalition reviewers may assess the deviation through an interactive interface, such as the system's graphical user interface (GUI). The GUI may provide a lineage-aware visualization of the model's behavioral trajectory and drift path, enabling decision-makers to trace the origins of the deviation and evaluate its mission impact. If the deviation is verified as benign or mission-appropriate, the alert may be dismissed and the drift profile updated; if confirmed as adversarial or catastrophic, the system may enforce rollback or revoke deployment authority. This drift detection workflow provides a scalable, real-time mechanism to ensure continuous alignment between Al model behavior and operational objectives-especially in environments where post-hoc audits or full retraining are not feasible. The ability to detect and act upon inference-level anomalies in real-time reinforces the system's zero-trust foundation and enables resilient Al governance in domains where failure, manipulation, or unsanctioned behavior can carry strategic consequences.

According to an embodiment of the present invention, the GUI displays outputs in various forms including visual and symbolic format to facilitate transparency and operational responsiveness. Users may inspect real-time drift visualizations, including deviation trajectories, affected input classes, and comparative topology graphs, through a secure dashboard. The dashboard enables human-in-the-loop interaction, allowing authorized personnel to confirm anomalies, override automated rollback triggers if mission context warrants it, or initiate further analysis across coalition networks. In high-consequence environments, the framework may be further augmented by policy-aware symbolic overlays, which map detected deviations to mission-specific rules or ethical constraints.

The architecture is uniquely designed to support federated learning in distributed, coalition-based, and bandwidth-constrained environments, enabling multiple stakeholders to collaborate on Al model development without centralizing sensitive data. In this paradigm, participating nodes, such as government agencies, allied defense units, or commercial data custodians, retain local control over their datasets while training model components independently. Rather than transmitting raw data to a central location, each node produces encrypted gradient updates or model weight adjustments that reflect its local learning context.

These encrypted contributions are transmitted through a SMPC validation engine, where they are securely aggregated into a unified global model. The SMPC validation engine ensures that no individual participant can view the raw contributions of others, preserving data confidentiality and intellectual property while still enabling joint optimization. Because the aggregation is done in a privacy-preserving manner, even adversarial nodes are limited in their ability to infer sensitive patterns from the updates of others, thereby reinforcing the platform's zero-trust posture.

Once aggregated, the resultant global model is cryptographically signed and versioned, with each federated contribution logged immutably in the blockchain ledger. This provides complete traceability over who contributed what, when, and under which conditions. If a performance anomaly or compliance issue is later identified, the system can trace the origin of a specific model segment, enabling targeted audits or revocation. This level of provenance is crucial in regulated environments, such as financial services or healthcare, where organizations must justify model behavior across multiple jurisdictions and stakeholders. The federated learning capabilities are particularly valuable in coalition-based defense or multinational research efforts, where data cannot be freely shared due to security classifications, legal restrictions, or national sovereignty concerns. In these settings, an embodiment of the present invention enables synchronized model advancement without violating data sovereignty principles. It also supports participation from non-traditional actors, such as academic institutions or private-sector partners, while protecting each party's contributions through privacy-preserving cryptographic methods.

In addition to federation under connected conditions, an embodiment of the present invention supports disconnected deployment, allowing edge devices, autonomous platforms, and remote nodes to continue functioning and learning independently when cut off from central infrastructure. Each node contains an embedded local compliance cache, which stores pre-authorized policies, behavioral thresholds, model lineage histories, and cryptographic keys for self-validation. This allows the system to enforce governance rules locally, detect anomalies, and even reject updates that do not conform to mission-specific constraints. These autonomous nodes are equipped with policy agents that operate according to embedded smart contracts and symbolic constraints.

For example, a node deployed in a space-based reconnaissance system may include preloaded rules governing the use of certain types of sensor data, red lines for privacy-preserving inferences, and/or escalation protocols if decision drift is detected. These rules remain enforceable even in complete isolation, enabling the systems to maintain integrity in domains where human oversight or real-time connectivity is infeasible.

Upon reconnection to secure infrastructure, disconnected nodes synchronize their local logs, inference histories, model updates, and drift events with the global compliance ledger. This ensures that all actions taken during the period of isolation are auditable, reconciled with central policies, and incorporated into the broader operational context. Smart contract logic embedded in the global ledger may also trigger revalidation or rollback if inconsistencies or violations are detected during synchronization. This synchronization process enables what might be termed “eventual governance”—the idea that full accountability can be restored even after periods of disconnection. Unlike traditional models that require constant connection for compliance enforcement, the system ensures that every decision and modification made during offline operation is eventually accounted for, cryptographically validated, and transparently reviewed by appropriate stakeholders.

In environments where adversarial conditions are expected, such as contested military zones, forward-deployed assets, or compromised civilian infrastructure, the federated and disconnected capabilities significantly enhance operational resilience. The system allows Al to continue functioning within bounded ethical and legal constraints, while also preparing for secure reintegration and oversight once communication is restored. This is particularly important for maintaining trust in autonomous systems that must act with a high degree of independence. By combining federated learning, cryptographic traceability, autonomous enforcement, and asynchronous synchronization, an embodiment of the present invention delivers a groundbreaking governance infrastructure that aligns with emerging regulatory frameworks (e.g., EU Al Act, U.S. Al Bill of Rights, NIST Al RMF, etc.). It empowers organizations to pursue collaborative, distributed Al development without compromising on compliance, privacy, or accountability thereby paving the way for responsible Al deployment at planetary scale.

The architecture may be purpose-built for mission-critical applications in which Al systems must operate independently while maintaining the highest levels of trust, transparency, and accountability. These applications span a wide range of domains where failure, compromise, or non-compliance can result in catastrophic consequences. For instance, autonomous military drones can execute tasks in contested environments while continuously verifying behavioral compliance and safeguarding against adversarial manipulation. Similarly, space-based Al agents aboard satellites or planetary probes must function without ground-based intervention, requiring embedded trust mechanisms that can detect model drift, validate decision logic, and enforce predefined operational constraints. In field-deployed healthcare environments, the system enables Al-powered diagnostic systems to function in remote or disconnected clinics, ensuring that clinical recommendations are traceable, explainable, and compliant with evolving medical policies—even when regulators are not immediately reachable.

For example, if a healthcare diagnostic model begins favoring a treatment pathway that was previously restricted by policy, the framework not only detects the statistical anomaly but flags the violation of the embedded constraint. This dual-layer assurance approach reinforces a commitment to both behavioral consistency and regulatory compliance, especially in scenarios where algorithmic decisions impact lives, assets, or national security. Ultimately, the framework transforms the way model drift is understood and managed in real-world Al deployments. By enabling real-time, topology-driven drift detection without reliance on labeled data, it supports resilient governance in disconnected, adversarial, or privacy-sensitive domains. Integration with cryptographic logging and policy automation ensures that Al systems governed by an embodiment of the present invention remain accountable, auditable, and mission-aligned throughout their operational lifecycle.

Beyond defense and healthcare, an embodiment of the present invention is highly applicable in financial services, critical infrastructure, and regulated industrial sectors, where Al-driven automation is increasingly deployed but subject to stringent compliance, privacy, and audit requirements. In high-frequency trading or credit risk modeling, for example, financial firms can use the framework to trace each inference back to its training history and compliance status—reducing legal exposure while satisfying regulatory obligations for explainability and fairness. In infrastructure security or utility management, an embodiment of the present invention allows Al agents embedded in power grids or transportation networks to make autonomous decisions during cyberattacks or network failures, while ensuring every decision is auditable and reversible once normal operations resume.

These capabilities position an embodiment of the present invention as a core component of digital sovereignty strategies and Al assurance frameworks around the globe. An embodiment of the present invention offers significant technical and operational advantages over existing governance systems. These include cryptographically verifiable model lineage and authorship, enabling secure traceability of any deployed model or update; real-time, model-agnostic drift detection that functions without labeled data or centralized oversight; and the ability to validate proprietary or black-box models using zero-knowledge proofs, preserving confidentiality while ensuring compliance. Its decentralized enforcement of compliance policies through smart contracts allows for autonomous decision control, even when Al systems are operating beyond traditional perimeters or in coalition settings. Finally, its robustness to adversarial tampering, offline deployment, and federated learning scenarios provide a resilient foundation for next-generation Al deployments across defense, healthcare, finance, space, and other strategic sectors where trustworthy autonomy is essential.

An embodiment of the present invention redefines the foundations of artificial intelligence governance by transitioning compliance from a reactive, externally enforced burden into an active, embedded layer of the Al lifecycle itself. Traditional compliance methods often rely on periodic audits, offline documentation, or manual inspection after deployment—practices that are increasingly insufficient in today's fast-moving, high-risk, and globally distributed Al ecosystems.

An embodiment of the present invention offers real-time, cryptographically enforced mechanisms that embed trust, verification, and oversight into the core of model behavior. This shift empowers Al systems to autonomously manage their compliance posture, validate their integrity, and respond to threats or deviations with minimal human intervention, even in disconnected or hostile environments. The system's integration of blockchain for immutable logging, secure multiparty computation (SMPC) for privacy-preserving validation, cryptographic watermarking for authorship verification, and the MAD-D framework for structural drift detection ensures comprehensive lifecycle assurance. These components do not operate in isolation but instead form a cohesive governance fabric that adapts as the Al system learns, evolves, or moves across jurisdictions and operational domains. Whether used in military operations, space-based systems, financial modeling, or healthcare diagnostics, an embodiment of the present invention provides a persistent thread of trust and accountability that cannot be severed—even when connectivity is lost or infrastructure is compromised. It enables decentralized enforcement of policies, multi-party consensus for updates, and transparent traceability for every decision and model update, eliminating the blind spots that have traditionally undermined confidence in autonomous systems.

Ultimately, an embodiment of the present invention positions itself as a foundational infrastructure for trustworthy Al—one that is aligned with national Al strategies, international regulatory frameworks, and ethical best practices. It is designed not just to meet today's compliance challenges but to scale with the future of Al, where models will be increasingly autonomous, decentralized, and interdependent. By embedding compliance as code and governance as a protocol, an embodiment of the present invention establishes a resilient and future-proof framework for mission-assured Al—ensuring that intelligent systems remain not only powerful and efficient, but also safe, transparent, and aligned with the values of the institutions that deploy them.

A number of implementations have been described. Nevertheless, it will be understood that various modifications may be made without departing from the spirit and scope of the disclosure. Accordingly, other implementations are within the scope of the following claims.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A system for decentralized governance and compliance of artificial intelligence (Al) models, the system comprising:
a blockchain-based ledger configured to immutably record lifecycle events of an Al model, wherein the lifecycle events comprise training metadata, configuration changes, updates, compliance validations, and operational deviations;
a secure multiparty computation (SMPC) engine configured to perform privacy-preserving validation of Al models or model updates across a plurality of federated parties without revealing sensitive internal model information or proprietary validation criteria;
a watermarking module configured to embed one or more blind cryptographic watermarks within internal components of the Al model, wherein the one or more blind cryptographic watermarks are verifiable through one or more cryptographic keys or zero-knowledge proofs and resilient to tampering;
a compliance enforcement module configured to autonomously trigger predefined policy responses based on conditions stored in smart contracts on the blockchain-based ledger, wherein the predefined policy responses comprise: rollback, model quarantine, or activation of a kill-switch; and
wherein the system is operable in disconnected or adversarial environments and further configured to synchronize cached ledger data with a global ledger when connectivity is reestablished.

2. The system of claim 1, wherein the blockchain-based ledger is further configured to execute smart contracts for automated enforcement of compliance rules, audit triggers, or threshold-based decision-making events.

3. The system of claim 1, wherein the SMPC engine comprises a plurality of cryptographic nodes, wherein each cryptographic node is configured to contribute encrypted data for validation and receive aggregated results without access to raw validation inputs of other cryptographic nodes.

4. The system of claim 3, wherein the plurality of cryptographic nodes are distributed across multiple organizational boundaries, and wherein each cryptographic node is associated with a distinct stakeholder.

5. The system of claim 1, wherein the watermarking module embeds the one or more blind cryptographic watermarks into one or more of: weight matrices, activation layers, or parameter configurations of the AI model, such that the one or more blind cryptographic watermarks are non-observable during normal inference operations.

6. The system of claim 5, wherein the watermarking module is configured to embed multiple layers of watermarks to support coalition attribution or layered compliance protocols.

7. The system of claim 1, wherein the compliance enforcement module is configured to autonomously perform model rollback to a previously verified state based on drift detection signals or failed validations.

8. The system of claim 1, further comprising a model deviation detection framework configured to perform topological or geometric analysis of inference patterns to detect structural drift or anomalous behavior without requiring labeled datasets.

9. The system of claim 8, wherein the model deviation detection framework utilizes at least one of: persistent homology, manifold learning, or similarity clustering to construct a behavior topology representing a structure of a decision space of the AI model.

10. The system of claim 1, wherein the system is operable in disconnected or adversarial environments and configured to synchronize cached ledger data stored in an offline blockchain cache with a global ledger when connectivity is reestablished.

11. The system of claim 10, further comprising an embedded local compliance cache configured to store pre-authorized policies, behavioral thresholds, model lineage histories, and cryptographic keys for self-validation during periods of disconnection from central infrastructure.

12. The system of claim 1, wherein the Al model is deployed in an environment selected from one or more of: a space-based satellite, a battlefield drone, a disconnected medical device, a critical infrastructure node, or a zero-trust data network.

13. A method for decentralized compliance assurance of an artificial intelligence model, comprising:
training the artificial intelligence model at a local node using local data;
embedding a blind cryptographic watermark into the artificial intelligence model during or after training;
validating the artificial intelligence model using a secure multiparty computation protocol across a plurality of validating parties without revealing sensitive internal model information of any validating party to other validating parties;
logging validation results and model metadata to a blockchain-based ledger configured to immutably record the validation results and the model metadata; and
enforcing compliance policies via smart contracts based on predefined rules stored on the blockchain-based ledger.

14. The method of claim 13, further comprising detecting model drift using a model-agnostic deviation detection engine that compares real-time inference signatures against baseline behavioral templates using topological or geometric analysis.

15. The method of claim 14, wherein the topological or geometric analysis comprises at least one of persistent homology, manifold learning, or similarity clustering to identify deviations classified as drift, shift, or anomaly.

16. The method of claim 13, wherein the plurality of validating parties comprises at least one regulatory authority and at least one model originator or deployer, and wherein each validating party contributes encrypted validation inputs that are aggregated to produce a consensus-based validation outcome.

17. The method of claim 13, further comprising autonomously triggering a model deactivation or revalidation event upon detection of a compliance anomaly or tampering event, wherein the model deactivation or revalidation event is governed by the smart contracts stored on the blockchain-based ledger.

18. A non-transitory computer-readable medium storing executable instructions which, when executed by a processor, cause an artificial intelligence governance system to:
monitor inference outputs of an artificial intelligence model in real-time;
initiate federated validation using secure multiparty computation when a model update is proposed, the federated validation performed across a plurality of validation parties without revealing sensitive internal model information of any validation party to other validation parties;
verify embedded cryptographic watermarks against blockchain ledger entries to confirm model integrity; and
execute smart contracts stored on a blockchain-based ledger to enforce compliance outcomes without human intervention.

19. The non-transitory computer-readable medium of claim 18, wherein the executable instructions further cause the artificial intelligence governance system to operate offline using a local compliance cache that stores pre-authorized policies, behavioral thresholds, and cryptographic keys for self-validation, and to perform secure synchronization with a global ledger when connectivity is restored.

20. The non-transitory computer-readable medium of claim 18, wherein the executable instructions further cause the artificial intelligence governance system to detect model drift by performing topological or geometric analysis of inference patterns to identify structural deviations without requiring labeled datasets and wherein the smart contracts define conditions for at least one of kill-switch activation, rollback to a previously verified model state, or alert generation based on behavioral thresholds or validation failures.
